(19) United States
(12) Patent Application Publication
(10) Pub. No.: US 2026/0072721 A1
(43) Pub. Date: Mar. 12, 2026

(54) VIRTUAL MACHINE DISPLAY WITH REDUCED VIRTUAL MACHINE MONITOR FOOTPRINT

(71) Applicant: Red Hat, Inc., Raleigh, NC (US)

(72) Inventors: Alberto Carlos Ruiz, Madrid (ES); Francisco Javier Martinez Canillas, Madrid (ES)

(21) Appl. No.: 18/829,732

(22) Filed: Sep. 10, 2024

(51) Int. Cl. G06F 9/455

(52) U.S. Cl. CPC G06F 9/45558; G06F 2009/45591

(57) ABSTRACT

Systems and methods are provided. A method can include obtaining, by a first user-space application operating in a user space of a guest operating system of a virtual machine, data indicative of a display frame associated with the virtual machine. In the method, the display frame can include imagery generated by a second user-space application operating in the user space. The method can include providing, by the first user-space application to a passthrough socket associated with a display component external to the virtual machine, the data indicative of the display frame.

### BACKGROUND

A virtual machine is a virtualization technology for emulating a physical computing system. A virtual machine typically runs a guest operating system in conjunction with a virtual machine monitor, such as a hypervisor, that is configured to coordinate access to physical resources of a “host” physical machine, such as a memory and a processor device, by one or more “guest” virtual machines running on the “host” physical machine.

### SUMMARY

The present disclosure is generally directed to systems and methods for providing a display for a virtual machine without needing to emulate a display device in a virtual machine monitor.

In one implementation, a method is provided. The method includes obtaining, by a first user-space application operating in a user space of a guest operating system of a virtual machine, data indicative of a display frame associated with the virtual machine, wherein the display frame comprises imagery generated by a second user-space application operating in the user space. The method further includes providing, by the first user-space application to a passthrough socket associated with a display component external to the virtual machine, the data indicative of the display frame.

In another implementation, a computing system is provided. The computing system includes one or more computing devices. The computing devices are to obtain, by a first user-space application operating in a user space of a guest operating system of a virtual machine, data indicative of a display frame associated with the virtual machine, wherein the display frame comprises imagery generated by a second user-space application operating in the user space. The computing devices are further to provide, by the first user-space application to a passthrough socket associated with a display component external to the virtual machine, the data indicative of the display frame.

In another implementation, a non-transitory computer-readable storage medium is provided. The non-transitory computer-readable storage medium includes executable instructions to cause a processor device to obtain, by a first user-space application operating in a user space of a guest operating system of a virtual machine, data indicative of a display frame associated with the virtual machine, wherein the display frame comprises imagery generated by a second user-space application operating in the user space. The instructions further cause the processor device to provide, by the first user-space application to a passthrough socket associated with a display component external to the virtual machine, the data indicative of the display frame.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2 is a sequence flow diagram of a method for providing a display for a virtual machine;

FIG. 3 is a flowchart diagram of a method for providing a display for a virtual machine;

FIG. 4 is a simplified block diagram of the environment illustrated in FIG. 1 according to one implementation; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A virtual computing device (“virtual machine) is a technology that runs on a physical computing device and performs computing operations. For example, a physical computing device may run multiple virtual machines, and a program called a virtual machine monitor may coordinate usage of the physical machine’s computing resources (e.g., memory devices, processor devices, etc.) between multiple virtual machines. Each virtual machine may appear, from the point of view of an application running on the virtual machine, to be no different from a standalone physical computing device.

One advantage of virtual machine is the ability to provide multiple isolated computing environments in a single physical machine. For example, in some instances, a server computing device may provide computing services (e.g., over the internet) to multiple users using a single physical computing device, with each user having access to a virtual machine on the server computing device. As another example, a computing device that performs both safety-sensitive functions and non-safety-sensitive functions (e.g., an on-board computer of a vehicle, etc.) can operate the safety-sensitive and non-safety-sensitive functions in separate isolated environments, thereby ensuring that the safety-sensitive functions will be unaffected by error conditions (e.g., software bugs, etc.) associated with the non-safety-sensitive functions.

However, operating a virtual machine may in some instances require emulating virtual hardware devices, such as emulated display devices or other hardware devices (e.g., emulated memory devices, file systems, input/output devices, etc.). In some instances, emulating a hardware device can include adding device emulation code to the virtual machine monitor that oversees the virtual machine. For example, in some instances, a virtual machine monitor can include a first body of computer code to emulate a hardware device (e.g., display device), and a second body of computer code to interact with an actual hardware device (e.g., display device), device driver, or other component (e.g., display server such as a Wayland compositor) associated with a physical hardware device.

However, adding additional code to a virtual machine monitor can have several disadvantages, such as cybersecurity and safety disadvantages; cost disadvantages; performance disadvantages; interoperability or compatibility disadvantages; and the like. For example, in the context of a computing device that performs safety-sensitive functions (e.g., on-board computer of a vehicle), software code that runs “outside” a virtual machine, such as code in a virtual machine monitor overseeing the virtual machine, can pose a greater safety risk than software code that operates inside the virtual machine. For example, because virtual machines can provide isolated computing environments, code running inside a first virtual machine may be isolated from a second virtual machine performing safety-sensitive functions, while a virtual machine monitor overseeing both virtual machines may not be isolated from the safety-sensitive functions. For that reason, any code added to a virtual machine monitor may pose a safety risk, and may require extensive safety testing to ensure safety. Similarly, adding code to a virtual machine monitor (VMM) may enlarge a cybersecurity attack surface of the VMM, increase a computational cost of running the VMM, decrease a performance of the VMM, and the like.

Advantageously, the examples set forth below include systems and methods that can provide a display for a virtual machine without adding device emulation code to the virtual machine monitor overseeing the virtual machine. For example, some examples set forth below describe a display application that can run inside the virtual machine and can communicate directly with a display component that is outside the virtual machine, such as a display server application that uses the Wayland communication protocol (sometimes referred to as a “Wayland compositor”). The display application can interact with the guest operating system running inside the virtual machine to obtain display frame data, such as display imagery generated by other applications running in the virtual machine. The display application can then provide the display frame data to an external display component, which can display the display frame without intervention from the virtual machine monitor. In this manner, for instance, display functions can be provided for applications running in a virtual machine, with a reduced virtual machine monitor footprint compared to some alternative implementations.

The examples set forth below can provide a variety of technical effects and benefits, such as improvements to computing technology. For example, in some instances, the examples set forth below can provide reduced computational cost (e.g., electricity cost, processor usage, memory usage, etc.); improved computational performance (e.g., latency, bandwidth, etc.); improved cybersecurity; improved safety; or improved interoperability or compatibility compared to some alternative systems and methods.

For example, in some instances, the examples set forth below can provide a display function for a virtual machine at reduced computational cost compared to some alternative methods. For example, some alternative implementations may include remote desktop protocols that may require an encoding step to encode display frame data before it is transmitted, and a decoding step to decode the display frame data before a frame is displayed. As another example, some alternative implementations may include virtual machine monitors that may run device emulation code to interact with a virtual device driver in a virtual machine; and display client code (e.g., Wayland client code) to interact with a display server. Each of these operations can increase a computational cost of operating the virtual machine. In contrast, the examples set forth below can in some instances provide a display for a virtual machine without one or more of: a remote desktop encoding step, a remote desktop decoding step, a virtual device driver separate from a display client, emulation code in a virtual machine monitor, or a display client executing in the virtual machine monitor. In this manner, for instance, the examples set forth below can in some instances provide a display for a virtual machine at reduced computational cost compared to some alternative methods.

As another example, in some instances, the examples set forth below can provide improved computational performance when providing a display function for a virtual machine compared to some alternative methods. For example, as described above, some alternative implementations may include performing additional computational steps that may not be required in the examples set forth below. In such instances, performing additional steps may increase a latency of performing a display operation; reduce a display bandwidth, frame rate, or the like; or cause other performance disadvantages. By reducing a number of computational operations that must be performed, the examples set forth below can in some instances provide improved computational performance compared to some alternative methods.

As another example, in some instances, the examples set forth below can provide improved functional safety compared to some alternative methods. For example, in some instances, a computing device (e.g., on-board computer of a vehicle, etc.) can perform both safety-sensitive functions (e.g., driver assistance functions such as collision detection, emergency braking, etc.) and non-safety-sensitive functions (e.g., navigation, media player functions, etc.) in one device. In some instances, the non-safety-sensitive functions can be performed inside a first virtual machine, and the safety-sensitive functions can be performed in an environment (e.g., second virtual machine, etc.) that is isolated from the first virtual machine. In such instances, reducing an amount of code that executes outside the first virtual machine can reduce a safety risk by reducing a number of computational operations that are not isolated from the safety-sensitive functions.

As another example, in some instances, the examples set forth below can provide improved cybersecurity compared to some alternative methods. For example, in some instances, computer code that executes outside of a virtual machine can represent a more significant cybersecurity attack surface than code that executes inside the virtual machine, which may in some instances be isolated from other code (e.g., security-sensitive code) executing in other virtual machines. Advantageously, the examples set forth below can in some instances reduce a VMM footprint compared to some alternative implementations, thereby reducing a size of a cybersecurity attack surface associated with code executing outside the virtual machine.

As another example, in some instances, the examples set forth below can provide improved interoperability or compatibility compared to some alternative methods. For example, some alternative implementations may include providing a display function by adding device emulation code to a virtual machine monitor. In such alternative implementations, migrating from a first virtual machine monitor to a second virtual machine monitor may require writing new device emulation code for the second virtual machine monitor, or may require rewriting virtual device driver code associated with the virtual machine to be compatible with a different device emulation protocol. Advantageously, the examples set forth below can in some instances include a display application that is portable between virtual machine monitors (e.g., VMMs that lack any knowledge of display communications protocols, display formats, or the like), sometimes requiring minimal or no modification of VMM code.

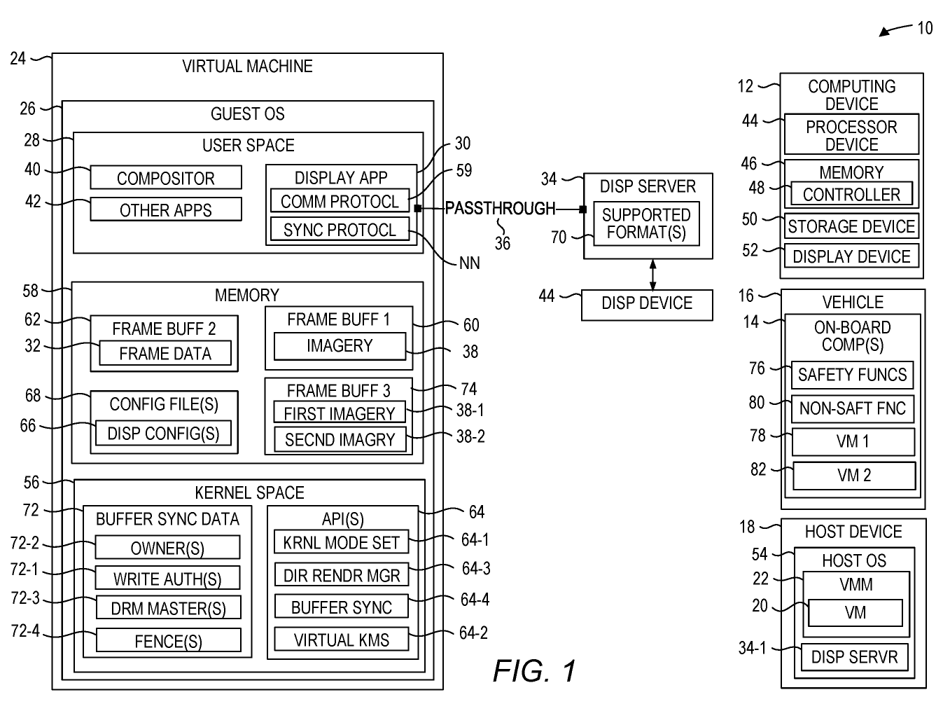

FIG. 1 is a block diagram of an environment in which examples disclosed herein may be practiced. A computing environment 10 can include one or more computing devices 12. In some instances, a computing device 12 can include an on-board computer 14 of a vehicle 16, or a host device 18 on which a virtual machine 20 or virtual machine monitor 22 is executing. In some instances, a virtual machine 20 can include a virtual machine 24 comprising a guest operating system 26. The guest operating system 26 can include a user space 28 in which user-space applications can execute. The user-space applications can include a display application 30 configured to provide display frame data 32 to a display server 34 via a passthrough socket 36. In some instances, the display frame can include imagery 38 generated by another user-space application, such as a compositor 40 or other application 42. In some instances, the display server 34 can interact with a display device 44 to provide a display for the virtual machine 24.

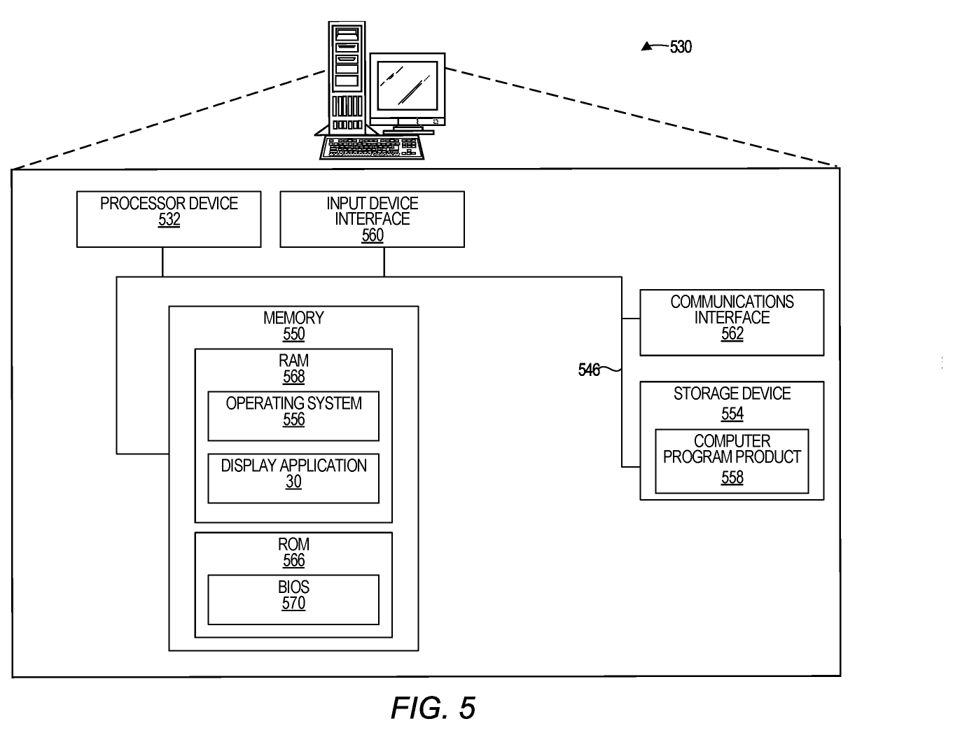

A computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 44, memories 46 comprising a memory controller 48, storage devices 50, or display devices 52. The computing device 12 can execute one or more processes (e.g., virtual machine 20, 24; host OS 54, VMM 22, etc.). Additional example implementation details for a computing device 12 are provided below with respect to FIG. 5.

An on-board computer 14 or host device 18 can be, comprise, be comprised by, or otherwise share one or more properties with a computing device 12. For example, an on-board computer 14 or host device 18 can in some instances have any property described above with respect to a computing device 12.

A host device 18 can include a computing device for hosting one or more virtual machines. In some instances, a host device can include a host operating system (OS) 54. In some instances, a virtual machine monitor 22 (VMM) can execute within the host OS 54. The VMM 22 (e.g., hypervisor, virtualizer, etc.) can implement a virtualized environment via VM virtualization technology on the host device 18. The VMM 22 can perform various functions, such as initializing, running, monitoring, configuring, overseeing, or otherwise managing one or more virtual machines (VMs) 20 operating within the host OS 54. As used herein, the terms “virtual machine monitor” and “hypervisor” can be considered interchangeable, and any action described as being performed by a virtual machine monitor 22 can be performed by a hypervisor and vice versa. A hypervisor can include, for example, a “bare metal” hypervisor running directly on native hardware; a “hosted” or “type 2” hypervisor (e.g., Quick Emulator (QEMU)) running on a host operating system (e.g., Red Hat Enterprise Linux, etc.); a kernel-based hypervisor module to cause a host operating system 54 to function as a hypervisor (e.g., Kernel-based Virtual Machine (KVM) hypervisor); and the like.

A virtual machine 20 can include, for example, an executing process to emulate a computing system or device. A virtual machine 20 can, for example, run one or more processes (e.g., guest operating system processes, software application processes, etc.) using virtual hardware (e.g., virtual memory, virtual processor device, etc.) mapped to physical hardware of the host device 18 by a virtual machine monitor 22.

A virtual machine 24 can be, comprise, be comprised by, or otherwise share one or more properties with a virtual machine 20. In some instances, the virtual machine 24 can operate in an environment that is the same as or different from an operating environment of a virtual machine 20. For example, the virtual machine 24 can in some instances execute on a host device 18 having a display server 34-1 external to the virtual machine 24 operating on the host device 18. However, other configurations are possible (e.g., display server 34 external to a host device 18, etc.) without deviating from the scope of the present disclosure.

A guest operating system 26 or host operating system 54 can include one or more software, firmware, or hardware functions for managing computational resources (e.g., hardware resources, etc.) of a virtual machine 24 or host device 18, respectively. In some instances, a guest OS 26 can belong to an OS family (e.g., Linux, Windows, iOS, Android, etc.) that is the same as or different from a host OS 54 operating on the same device. In some instances, a guest OS 26 can comprise an OS version (e.g., Red Hat Enterprise Linux 7, etc.) that is the same as or different from an OS version of a host OS 54 operating on the same device. A guest operating system 26 can be, for example, an operating system running within the virtual machine 24 (e.g., in an environment isolated from other virtual machines, etc.) overseeing functions associated only with the virtual machine 24. A host operating system 18 can be, for example, an operating system running outside a virtual machine 20, 24, and may oversee functions associated with a host device 18 that occur outside a virtual machine 20. As a non-limiting illustrative example, a host device 18 may include a Red Hat Enterprise Linux 7 host operating system 54 overseeing functions associated with the physical computing resources of a host device 18, and a virtual machine 20, 24 executing on the host device 18 (e.g., inside a VMM 22) can include a Red Hat Enterprise Linux 7 guest operating system 26 executing within the virtual machine 20, 24 that is separate from the host operating system 54, and the guest operating system 26 can oversee functions associated with one or more virtual computing resources of the virtual machine 20, 24. The virtual resources can include, for example, virtual resources that are assigned, allocated, or mapped to physical resources by a VMM 22.

A guest operating system 26 can include, for example, a kernel space 56 in which a kernel of the guest OS executes and a user space 28 in which applications that are not part of the kernel (e.g., device driver applications, user-facing applications, etc.) can execute. A kernel can include, for example, one or more functions executing in a privileged mode (e.g., “kernel mode”), such as one or more functions having a highest privilege level of a plurality of privilege levels. A user-space 28 function can include, for example, a function having a privilege level that is lower than the highest privilege level of the plurality of privilege levels.

The guest operating system 26 or virtual machine 24 can include or have access to physical or virtual memory 58, which can include memory 58 that is located in or accessible from the user space 28; memory 58 that is located in or accessible from the kernel space 56; or memory that may be shared between the kernel space 56 and user space 28 (e.g., responsive to one or more memory allocations controlled by a kernel of the guest operating system 26, etc.). In some instances, the memory 58 can include a plurality of separate memory regions, such as a plurality of user-space memory regions associated respectively with a plurality of user-space applications 30, 40, 42. For example, in some instances, each user-space application 30, 40, 42 may be assigned its own memory region, which other user-space applications 30, 40, 42 cannot access unless explicitly allowed. The memory 58 can include physical or virtual memory 58, such as virtual memory 58 that is mapped to physical memory (e.g., associated with a memory device 46) by a VMM 22 overseeing a virtual machine 24. Further details of example physical memory devices are provided below with respect to FIG. 5.

The display application 30 can include, for example, one or more software, firmware, or hardware functions for obtaining (e.g., retrieving, receiving, generating, determining, etc.) display frame data 32 comprising imagery generated by other user-space applications 40, 42 and providing the display frame data 32 to a display server 34 external to the virtual machine 24 via a passthrough socket 36. The display frame data 32 can be obtained in various ways, such as by retrieving the frame data 32 from a memory location (e.g., frame buffer 60, 62, etc.); receiving the frame data 32 via one or more inter-process communication channels (e.g., file, signal, pipe, socket, message queue, message passing protocol, shared memory, etc.); generating the frame data 32 (e.g., based on imagery 38, etc.); or other method for obtaining.

Display frame data 32 can include, for example, any data for representing one or more display frames or components thereof in a digital format. In some instances, display frame data 32 can include raster image data (e.g., compressed or uncompressed bitmap data, pixel map data, etc.) or vector image data. In some instances, display frame data 32 can include data in a format associated with a communication protocol 59 associated with a display server 34. In some instances, display frame data 32 can include data in a format that is the same as or different from a format of imagery 38 data generated by one or more user-space applications 40, 42 different from the display application 30.

In some instances, obtaining the display frame data 32 can include retrieving display data (e.g., imagery 38) from a first frame buffer 60. For example, in some instances, the display application 30 can initialize a first frame buffer 60 (e.g., via one or more calls to an application programming interface 64 or the guest OS 26, etc.). The display application 30 can then provide, to another user-space application 40, 42, access to the frame buffer 60. The other user-space application 40, 42 can then write display frame data 32 or other imagery 38 data to the frame buffer 60, and the display application 30 can subsequently retrieve the data from the frame buffer 60.

In some instances, initializing, providing access to, or reading data from the frame buffer 60 can include one or more calls to one or more application programming interfaces (APIs) 64 of a kernel of the guest OS 26. For example, in some instances, initializing the frame buffer can include calling an API (e.g., kernel mode setting API 64-1 or virtual kernel mode setting API 64-2) to obtain display configuration information or set display configuration settings (e.g., display mode settings, etc.). As another example, in some instances, sharing access to the frame buffer 60 can include calling one or more APIs 64 (e.g., direct rendering manager API 64-3, etc.) to provide access to or otherwise configure a frame buffer 60 owned by the display application 30. As another example, in some instances, reading from the frame buffer 60 can include calling one or more APIs 64 (e.g., buffer synchronization API 64-4, etc.) to synchronize the reading with one or more other operations. In some instances, an API 64 can include a standard (e.g., unmodified, out-of-the-box, etc.) API 64 (e.g., standard Linux KMS/DRM API 64-1, 64-2, 64-3 associated with a Linux distribution, etc.) or a modified API 64, such as an API that has been modified with a mechanism to enable a display application 30 to gain ownership of a frame buffer 62 owned by the display server 34.

In some instances, initializing the frame buffer 60 can include obtaining configuration information for configuring the frame buffer 60, and configuring the frame buffer 60 based on the configuration information. In some instances, obtaining configuration information can include retrieving display configuration data 66 from a configuration file 68. Display configuration data 66 can include data indicative of one or more preferred display configurations, such as a screen resolution, color depth, refresh rate, or the like. In some instances, obtaining display configuration information can include negotiating a display mode with the display server 34. For example, in some instances, a display server 34 can provide, via a passthrough socket 36, data indicative of one or more supported display formats 70. Based on the data indicative of the supported formats 70 (e.g., based on a comparison between the supported formats 70 and one or more preferred display configurations of the configuration data 66, etc.), the display application 30 can determine a display mode (e.g., resolution, etc.) or other configuration associated with the frame buffer 60. In some instances, obtaining configuration information can include obtaining display configuration information from an API 64, such as a kernel mode setting (KMS) API 64-1 (e.g., Linux KMS API, etc.), virtual KMS API 64-2 (e.g., Linux drm/vkms API, etc.), or direct render manager (DRM) API 64-3 (e.g., Linux DRM API, etc.). For example, in some instances, a current display mode setting (e.g., screen resolution, refresh rate, etc.) can be retrieved via a KMS or virtual KMS API 64-1, 64-2.

In some instances, initializing the frame buffer 60 can include configuring the frame buffer 60 according to the obtained configuration information. For example, in some instances, initializing the frame buffer 60 can include determining a size for the frame buffer 60 based on a resolution associated with a display mode, a color depth (e.g., 4-bit or 8-bit palettized, 16-bit high color, 24-bit true color, etc.) associated with the display mode, or other configuration information. As another example, in some instances, a KMS or virtual KMS API 64-1, 64-2 can be called to update a display mode setting associated with the frame buffer 60 based on the configuration information (e.g., resolution, etc.). As another example, initializing the frame buffer 60 according to the obtained configuration can include configuring or determining one or more access parameters associated with the frame buffer 60. For example, in some instances, a DRM API 64-3 can be called to configure one or more access parameters associated with the buffer, such as an access control list or other set of rules for determining which entities (e.g., applications 40, 42) may access the frame buffer 60; a display mode (e.g., resolution, color depth, etc.) or other display parameter associated with the frame buffer 60; a protocol or interface (e.g., API) for accessing the frame buffer; or other access parameters.

Providing access to the frame buffer 60 can include various operations, such as KMS/DRM operations, buffer sync operations, or other access control operations. In some instances, providing access to the frame buffer 60 can include declaring, via a KMS/DRM API 64-1, 64-2, 64-3, the frame buffer 60 as a buffer associated with a display device (e.g., virtual display device, etc.). In some instances, providing access to the frame buffer 60 can include providing buffer data (e.g., buffer address, buffer format, etc.) associated with the frame buffer 60 to an API 64 (e.g., virtual KMS API 64-2, etc.) and causing the API 64 to expose the frame buffer 60 to one or more user applications 40, 42 (e.g., by exposing to the user space 28 as an available display device, etc.). In some instances, providing access to the frame buffer 60 can include providing write permission to a kernel of the guest OS 26 (e.g., API 64 of the kernel, etc.), wherein other user-space applications 40, 42 can access the frame buffer 60 via the kernel (e.g., via an API 64, such as a virtual KMS API 64-2, etc.). In some instances, providing access to the frame buffer 60 can include providing access through an API 64 of the guest OS 26, such that user-space applications 40, 42 can transparently provide imagery 38 to the API 64 (e.g., virtual KMS API 64-2) according to standard API interactions (e.g., without knowledge of a display server 34 or display application 30; without knowledge of a communication protocol 59 associated with the display server 34). For example, in some instances, a user-space application 40, 42 can provide imagery 38 to the display application via a first protocol (e.g., API 64); and the display application 30 can provide frame data 32 corresponding to the imagery 38 via a second protocol (e.g., communication protocol 59) that is different from the first protocol. In some instances, providing access to the frame buffer 60 can include declaring, via a KMS/DRM API 64-1, 64-2, 64-3, the display application 30 as a device driver for the display device associated with the frame buffer 60. In some instances, providing access to the frame buffer 60 can include initializing a device driver data structure associated with the display application 30; allocating, based on the device driver data structure, a display device instance (e.g., virtual display device instance associated with the frame buffer 60); and registering the display device instance via the KMS/DRM API 64-1, 64-2, 64-3. In some instances, providing access to the frame buffer 60 can include configuring, via a KMS/DRM API 64-1, 64-2, 64-3, one or more access rules (e.g., interfaces, protocols, access control lists, permissions, etc.) for accessing the frame buffer 60.

In some instances, the guest OS 26 kernel (e.g., a KMS/DRM API 64-1, 64-2, 64-3 or the guest OS 26 kernel) can store display device data such as a data structure (e.g., list, etc.) comprising data indicative of one or more display devices that are available to user-space applications 40, 42; data indicative of one or more device drivers, frame buffers 60, 62, or access rules associated with the display devices; or the like. In some instances, the KMS/DRM API 64-1, 64-2, 64-3 can update the display device data responsive to receiving, from the display application 30, a signal (e.g., API call) to configure the display device data. In some instances, other user-space applications 40, 42 can request and receive (e.g., from a KMS/DRM API 64-1, 64-2, 64-3), retrieve, or otherwise obtain some or all of the display device data (e.g., a list of available devices, drivers, frame buffers 60, 62, etc.). In some instances, the other user-space applications 40, 42 can access, based at least in part on display device data (e.g., display device data received from a KMS/DRM API 64-1, 64-2, 64-3), the frame buffer 60 (e.g., by writing imagery 38 to the frame buffer 60).

In some instances, the guest OS 26 can store buffer synchronization and access control data 72 to track buffer access permissions and synchronization states. In some instances, providing access to, reading from, or writing to the frame buffer 60 can include interacting with one or more APIs 64 based at least in part on buffer synchronization or access control data 72.

Providing access to the frame buffer 60 can include, for example, designating (e.g., using an API 64) one or more user-space applications 40, 42 as authorized entities having write authorization 72-1 to all or part of the frame buffer 60. For example, providing access to the frame buffer 60 can in some instances include interacting with a direct rendering manager (DRM) API 64-3. For example, in some instances, a display application 30 can obtain (e.g., initialize, allocate, define, request allocation of, receive, etc.) a frame buffer 60 in memory 58 (e.g., memory 58 space owned by the display application 30); and designate, using the DRM API 64-3, another user-space application as a DRM master of all or part of the frame buffer 60. Responsive to the designating, the DRM API 64-3 or other kernel component of the guest OS 26 can provide the designated DRM master with access to the frame buffer 60. In some instances, the display application 30 can be an owner 72-2 (e.g., “owner” DRM master 72-3) of the frame buffer 60, and the designated user-space application can be a “lessee” (e.g., lessee DRM master 72-3) of the frame buffer 60. In some instances, the display application 30 can lease the frame buffer 60 to a single user-space application designated to be the sole user-space application 40, 42 other than the display application 30 with write access to the frame buffer 60 or designated portion thereof.

In some instances, providing access to the frame buffer 60 can include interacting with a buffer synchronization (sync) API 64-4 (e.g., dma-buf API, etc.). Similarly, accessing, by the display application 30 or other user-space application 40, 42 can include interacting with the buffer sync API 64-4. For example, in some instances, a buffer sync API 64-4 can coordinate allocation of one or more buffer fences 72-4 (e.g., locks, mutexes, scheduling controls, dma-buf fences, memory fences, etc.) to coordinate access to the frame buffer. For example, prior to writing imagery 38 data to a frame buffer 60, a user-space application 40, 42 (e.g., lessee DRM master, etc.) can request, via the buffer sync API 64-4, allocation of a fence 72-4 for the frame buffer 60. Responsive to the request, the guest OS 26 kernel can allocate the fence 72-4 to the user-space application 40, 42. Responsive to the allocation, the user-space application 40, 42 can write imagery 38 data to the frame buffer 60. After completing the writing, the user-space application 40, 42 can release the fence 72-4. Responsive to the releasing, the guest OS 26 kernel can determine whether any fences 72-4 associated with the frame buffer 60 still exist. In some instances, the buffer sync API 64-4 can, responsive to determining that the frame buffer 60 has no associated fences 72-4, notify the display application 30 that the frame buffer 60 has been released. In some instances, the buffer sync API 64-4 can allocate a fence 72-4 to the display application 30 (e.g., responsive to a fence allocation request from the display application 30). Responsive to a notification that the frame buffer 60 has been released or responsive to allocation of a frame buffer 60 fence 72-4 to the display application 30, the display application 30 can read from the frame buffer 60 or otherwise access the frame buffer 60 (e.g., in order to obtain frame data 32 or provide frame data 32 to a display server 34).

In some instances, a user-space application 40, 42 writing to the frame buffer 60 can include a compositor 40 (e.g., Wayland compositor, X Window compositor, etc.) or another user-space application 42. For example, in some instances, a single user-space application 42 may write full-frame imagery 38 data describing an entire display frame to the frame buffer 60 (e.g., when a display of the virtual machine 24 is not shared between user-space applications 42, etc.). As another example, in some instances, a first user-space application 42 can write first imagery 38-1 to a frame buffer 74 associated with (e.g., owned by, etc.) the compositor 40; a second user-space application 42 can write second imagery 38-2 to the frame buffer 74 associated with the compositor 40; and the compositor 40 (e.g., compositor 40 executing in user space 28 of the guest OS 26 of the virtual machine 24) can generate composite full-frame imagery 38 data based on the first imagery 38-1 and the second imagery 38-2. The compositor 40 can then write the composite imagery 38 data to a frame buffer 60 controlled by the display application 30.

A frame buffer 60, 62, 74 can include, for example, a memory region used to store display frame data 32, imagery 38 data, or other data (e.g., display parameter data or display mode data, buffer sync data 72, etc.). For example, a frame buffer 60, 62, 74 can include a memory region for temporary storage of data 32, 38 associated with individual display frames, which may be periodically updated according to a frame rate or refresh rate (e.g., 60 frames per second, etc.).

Imagery 38 data can include, for example, any data indicative of imagery generated by one or more user-space applications 40, 42, such as raster image data (e.g., bitmap data) indicative of all or part of a display frame; vector image data; or other imagery 38 data. First and second imagery 38-1 and 38-2 can include, for example, imagery 38 generate by first and second user applications 42 or the like.

Subsequent to obtaining imagery 38 data from a frame buffer 60, the display application 30 can provide frame data 32 to a passthrough socket 36 associated with a display server 34 external to the virtual machine. In some instances, the imagery 38 data can be the same as or different from the frame data 32. For example, the frame data 32 can have a format (e.g., bitmap or pixel map format; display mode such as resolution, color depth, etc.; or the like) that is the same as or different from a format of imagery 38 obtained from a frame buffer 60. In some instances, generating frame data 32 or providing frame data 32 to a passthrough socket 36 can in some instances include wrapping, reformatting, translating, or otherwise modifying imagery 38 data to comply with one or more requirements associated with the display server 34, such as a communication protocol 59 of the display server 34, a supported format 70 supported by the display server 34, or other requirement.

In some instances, providing frame data 32 to a passthrough socket 36 can include wrapping frame data 32 or imagery 38 with additional data, such as one or more commands (e.g., subroutine calls, API calls, etc.), parameters, or the like. For example, providing frame data 32 to a passthrough socket 36 can include wrapping frame data 32 according to a communication protocol 59 (e.g., Wayland communication protocol, etc.) associated with a display server 34 to generate a display command, function call, or other message according to the communication protocol 59; and providing the message to the display server 34 via the passthrough socket 36.

A display server 34 can include, for example, one or more software, firmware, or hardware components to provide display functions based at least in part on data received from a passthrough socket 36. In some instances, a display server 34 can include a compositing window manager (“compositor”) configured to receive imagery data from a plurality of different sources (e.g., plurality of display applications 30 in different virtual machines 24; display application 30 and other components, such as user-space applications executing in user space of a host OS 54; etc.) and generate, based on the received imagery data, data indicative of a composite display frame comprising portions of imagery data from two or more sources. In some instances, the display server 34 can provide display frame data (e.g., data indicative of the composite display frame, etc.) to a display device 44. In some instances, the display server 34 can include an application configured to coordinate display operations based on a communication protocol 59 associated with the display server 34. For example, in some instances, a display server 34 can include a Wayland compositing window manager (“Wayland compositor”) associated with the Wayland communication protocol 59. Other types of display server 34 (e.g., X Window compositor, non-compositing display server 34, etc.) can be used without deviating from the scope of the present disclosure. In some instances, a display server 34 can be a type of display server (e.g., compositor, Wayland compositor, etc.) that is the same as or different from a display server type associated with a compositor 40.

A passthrough socket 36 can include, for example, a communication endpoint for communication between a process or component (e.g., display application 30, etc.) internal to the virtual machine 24 and a process or component (e.g., display server 34) external to the virtual machine 24 (e.g., an external process executing on a computing device 12 that is the same as or different from a computing device 12 on which the virtual machine 24 is executing). In some instances, a passthrough socket 36 can include a communication endpoint configured to pass a communication (e.g., message, signal, etc.) directly from the display application 30 to the display server 34 with little or no modification performed by the passthrough socket 36, VMM 22, host OS 54, or other process or component. In some instances, a passthrough socket 36 can include a Wayland passthrough socket 36 for communicating with a Wayland compositor, such as a Wayland passthrough socket 36 provided by a virtio-GPU device emulation process.

A communication protocol 59 can include, for example, any protocol (e.g., rules, syntax, synchronization, API, etc.) for communicating with a display server 34. For example, in some instances, a communication protocol 59 can include a Wayland communication protocol or another display communication protocol (e.g., X Window communication protocol, Remote Desktop Protocol, etc.).

A display device 44 can include any device to display imagery associated with a virtual machine 24, such as a computer monitor, touchscreen display, television, or other display device.

In some instances, providing frame data 32 to the display server 34 can include causing the frame data 32 to be written to a frame buffer 62 that is accessible to the display server 34. In some instances, the frame buffer 62 can be the same as or different from a frame buffer 60 to which a user-space application 40, 42 can write imagery data. For example, in some instances, a display application 30 can gain access to or control of (e.g., become an owner or lessee DRM master 72-3 of, etc.) a frame buffer 62 for which a display server 34 (e.g., display server 34 executing on a host device 18 on which the virtual machine 24 is executing, etc.) has read access; and provide access to the frame buffer 62 to one or more user-space applications 40, 42 (e.g., according to methods described above). In some instances, the display application 30 can provide frame data 32 (e.g., frame data 32 comprising imagery 38 written to the frame buffer 60 by a user-space application 40, 42) to the display server 34 by providing, via the passthrough socket 36, a message (e.g., message formatted according to a communication protocol 59) indicating that the frame buffer 62 is ready. Responsive to receiving such a message, the display server 34 can read the frame data 32 from the frame buffer 62; can generate display data based at least in part on the frame data 32; and provide the display data to a display device 44 for display to a user. In some instances, the message can include additional data, such as data indicative of one or more display parameters (e.g., resolution, color depth, format, etc.) associated with the frame data 32. As another example, in some instances, a display application 30 can gain write access to the frame buffer 62; and provide, to a user-space application 40, 42, access to a frame buffer 60 that is separate from the frame buffer 60. In such instances, providing the frame data 32 to the display server 34 may include copying imagery 38 data to the frame buffer 62 or otherwise writing frame data 32 to the frame buffer 62 based at least in part on the imagery 38 data (e.g., by translating, encoding, or otherwise transforming imagery 38 data, etc.).

In some instances, the display server 34 can include a display server 34 executing on a host device 18 on which a virtual machine 20, 24 is executing. For example, the display server 34 can execute in an area of a host device that is external to the virtual machine 20, 24. In some instances, a host device 18 can include shared memory that can be shared between the virtual machine 20, 24 or components thereof and the host device 18 or components thereof that may be external to the virtual machine 20, 24. For example, in some instances, a host OS 54, VMM 22, or other process of the host device 18 can include a mechanism for allocating shared memory between processes internal to the virtual machine 20, 24 and processes external to the virtual machine 20, 24. In some instances, the display application 30 can send a request (e.g., to a display server 34, VMM 22, etc.) to allocate a frame buffer 62 in memory 58 space shared between the display server 34. In some instances, the display server 34 can receive the request and, responsive to receiving the request, allocate the frame buffer 62. In some instances, the display application 30 can gain access to or control of the frame buffer 62 (e.g., during a startup process of the virtual machine 24, etc.). For example, in some instances, a display application 30 can, responsive to startup of the virtual machine 24 or startup of the display application 30, request allocation of the frame buffer 62; receive an indication that the frame buffer 62 has been allocated; request access to the frame buffer 62 (e.g., from an API 64 of the guest OS 26 kernel, etc.); and receive access to the frame buffer 62. In some instances, the display application 30 can become a DRM master 72-3 (e.g., owner DRM master, lessee DRM master, etc.) of a frame buffer 62 shared with the display server 34 (e.g., by requesting ownership or DRM master 72-3 status from a DRM API 64-3 or buffer sync API 64-4, etc.).

In some instances, a display application 30 and display server 34 can negotiate a display format prior to initializing a frame buffer 60, 62. For example, in some instances, a display application 30 can request, via a passthrough socket 36, data indicative of one or more supported formats 70 supported by the display server 34. Responsive to receiving the requested data, the display application 30 can compare the supported formats 70 to one or more preferred display configurations 66 (e.g., retrieved from a configuration file 68, etc.), and can select a display format based on the comparison. In some instances, the frame buffer 62 can be allocated based at least in part on the selected display format. For example, in some instances, a size, dimension, or other property of the allocated frame buffer 62 may be based at least in part on the selected display format.

Supported formats 70 can include, for example, data indicative of one or more display formats supported by the display server 34. A display format can include, for example, a screen resolution, a color depth, a refresh rate, an encoding format (e.g., pixel map, etc.), or other display format parameters.

In some instances, the virtual machine 24 can execute on an on-board computing device 14 of a vehicle 16. In some instances, a vehicle 16 can include a road vehicle, such as a passenger vehicle (e.g., sedan, coupe, sport utility vehicle, pickup truck, bus, limousine, etc.), cargo vehicle (e.g., tractor-trailer vehicle, box truck, etc.), military road vehicle (e.g., armored personnel carrier, etc.), or other road vehicle. In some instances, an on-board computing device 14 can include a computing device for performing one or more safety-sensitive functions. For example, in some instances, an on-board computing device 14 can control one or more of: turn signals, windshield wipers, brakes (e.g., as part of a collision-avoidance driver assistance system, anti-lock braking, etc.), transmission, steering, traction control (e.g., during braking, steering, or acceleration), or other safety-sensitive vehicle components. In some instances, an on-board computing device 14 may execute one or more safety-sensitive functions 76 in a first isolated environment (e.g., container, first virtual machine 78, etc.), and may execute one or more non-safety-sensitive functions 80 in a second isolated environment (e.g., container, second virtual machine 82, etc.) executing on the same on-board computing device 14. For example, a user space 28 of the second virtual machine 82 for executing non-safety-sensitive functions 80 can in some instances include a display application 30, a compositor 40, and a plurality of other applications 42 (e.g., media player applications, navigation applications, etc.) executing in the second virtual machine 82. In such instances, running a display application 30 in user space 28 of one or more of a first virtual machine 78 and second virtual machine 82 (e.g., instead of including display device emulation code in a VMM 22) can advantageously reduce a safety risk to the safety-sensitive functions 76 from failures (e.g., errors, exceptions, bugs, etc.) in processes that are executing in an environment that is not isolated from the first virtual machine 78.

In some instances, a safety-sensitive function 76 can include a function that is classified by the 2018 edition of ISO 26262 as Automotive Safety Integrity Level (ASIL) A, B, C, or D. ISO 26262 is an international standard for functional safety of road vehicles defined by the International Organization for Standardization (ISO). For clarity, as used herein, ISO 26262:2018 classifications of vehicle functions are considered to be independent of whether the 2018 edition of ISO 26262 actually governs, regulates, or otherwise applies to the vehicle 16. For example, a vehicle 16 function can be classified by the ISO 26262:2018 as ASIL A, B, C, or D irrespective of whether a manufacturer, owner or other person associated with the vehicle 16 complies or attempts to comply with ISO 26262; irrespective of whether the 2018 edition is the latest edition of ISO 26262; and the like. In some instances, a non-safety-sensitive function 80 can include a function that is not a safety-sensitive function 76 (e.g., a function that is not classified by ISO 26262:2018 as ASIL A, ASIL B, ASIL C, or ASIL D, etc.). In some instances, a first or second virtual machine 78, 82 can be, comprise, be comprised by, or otherwise share one or more properties with a virtual machine 20 or virtual machine 24.

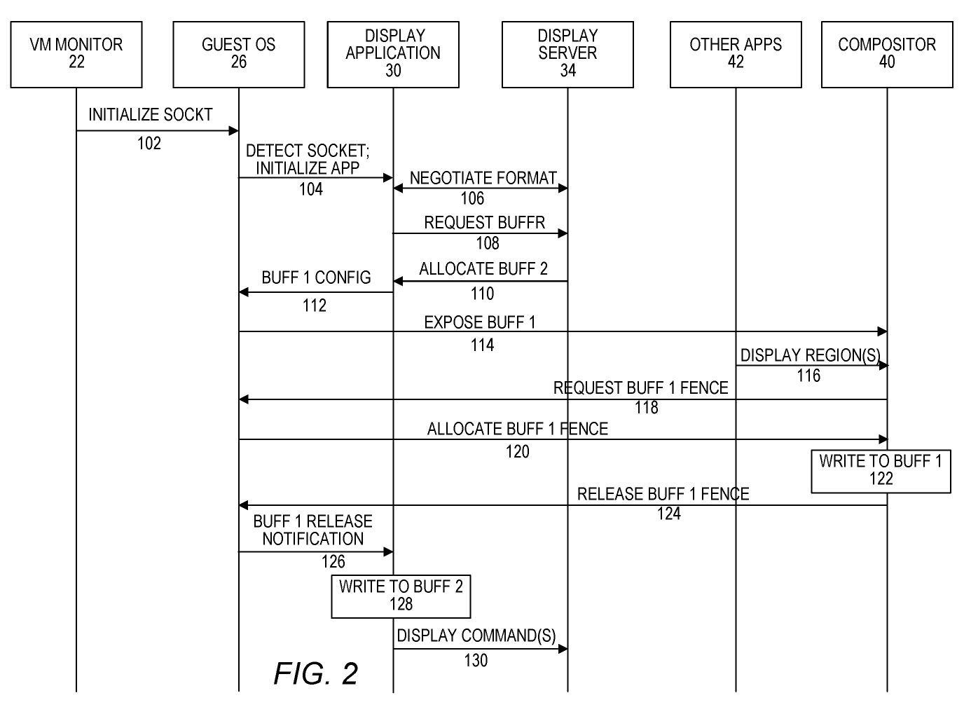

FIG. 2 is a sequence flow diagram of a method for providing a display for a virtual machine. At 100 through 112, the VMM 22, guest OS 26, display application 30, and display server 34 can interact to initialize one or more frame buffers 60, 62 for reading and writing display frame data 32. At 114 through 130, the guest OS 26, display application 30, display server 34, compositor 40, and other applications 42 can work together to provide a display comprising imagery generated by the other applications 42. Although FIG. 2 depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 102, a virtual machine monitor 22 can initialize a passthrough socket 36 and provide the passthrough socket to a guest OS 26.

At 104, a guest OS 26 or display application 30 can detect whether a passthrough socket 36 is available, and initialize the display application 30 if a passthrough socket 36 is available. For example, in some instances, the guest OS can check for the passthrough socket 36; and, responsive to detecting an available passthrough socket 36, initialize (e.g., start up, etc.) the display application 30. As another example, in some instances, the guest OS can startup the display application 30 (e.g., on startup of a virtual machine 24); the display application 30 can check for a passthrough socket 36; and, responsive to determining that no passthrough socket 36 is available, the display application 30 can shut itself down or perform another error response action (e.g., initializing a different display application, sending an error message to a VMM 22, etc.). Other implementations are possible.

At 106, the display application 30 and display server 34 can negotiate a display format. For example, the display application 30 can request and receive supported format 70 data; retrieve or otherwise obtain display configuration 66 data; and select a display format based on one or more of the supported format 70 data and display configuration 66 data.

At 108, the display application 30 can request (e.g., via the passthrough socket 36) allocation of a frame buffer 62 by the display server 34. At 110, the display server 34 can allocate the frame buffer 62. In some instances, the display server 34 can send, and the display application 30 can receive, data indicative of a successful allocation of the frame buffer 62 (e.g., memory address data indicative of a location of the frame buffer 62 in memory space; success message; etc.)

At 112, the display application 30 can initialize, cause to be initialized, or otherwise configure a frame buffer 60 (e.g., using one or more APIs 64 as described above) to be provided to (e.g., shared with in shared memory, exposed via an API 64, etc.) one or more other user-space applications 40, 42. At 114, the display application 30 can provide access to all or part of the frame buffer 60 to one or more other user-space applications 40, 42, such as the compositor 40.

At 116, one or more user-space applications 42 can provide imagery 38 data associated with one or more display regions (e.g., overlapping windows or other display regions). The compositor 40 can then generate, based on the display region data, imagery 38 data indicative of a composite display frame.

At 118 through 124, the compositor 40 can write to the frame buffer 60 according to a buffer sync protocol. At 118, the compositor 40 can request a fence. At 120, the guest OS 26 (e.g., a buffer sync API 64-4 of the guest OS) can allocate the fence. At 122, the compositor 40 can write the composite imagery 38 data to the frame buffer 60. At 124 the compositor 40 can release the fence (e.g., via a buffer sync API 64-4 of the guest OS).

At 126, the display application 30 can receive notification that the frame buffer 60 has been released by the compositor (e.g., notification that no fences are attached to the frame buffer 60, indication that the frame buffer 60 is not currently being written to, etc.). In some instances, at 126, the display application 30 can request and receive allocation of a fence for the frame buffer 60.

At 128, the display application 30 can read the imagery 38 data from the frame buffer 60 and write corresponding frame data 32 to the frame buffer 62 based at least in part on the imagery 38 data. Other implementations are possible (e.g., sharing a single frame buffer 60, 62 with a display server 34 and a user-space application 40, 42; passing a message to the display server 34 according to a communication protocol 59 via means other than a frame buffer 62; etc.).

At 130, the display application 30 can provide one or more communications (e.g., commands, signals, messages, API calls, etc.) to the display server 34 indicating that the frame data 32 is ready for display or processing by the display server 34 or a display device 44.

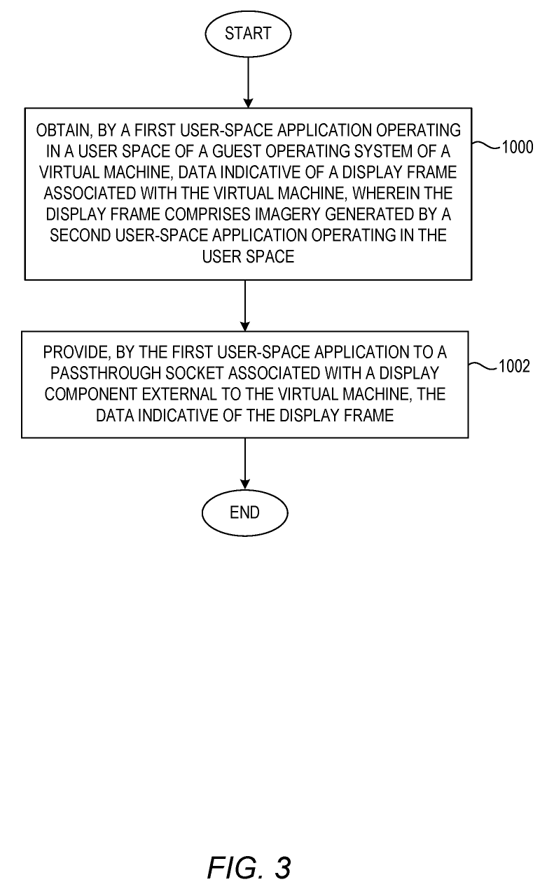

FIG. 3 is a flowchart diagram of a method for providing a display for a virtual machine. Although FIG. 3 depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 1000, the method of FIG. 3 can include obtaining, by a first user-space application (e.g., display application 30, etc.) operating in a user space (e.g., user space 28, etc.) of a guest operating system (e.g., guest operating system 26) of a virtual machine (e.g., virtual machine 20, 24, 78, 82, etc.), data (e.g., frame data 32, etc.) indicative of a display frame associated with the virtual machine, wherein the display frame comprises imagery (e.g., imagery 38, etc.) generated by a second user-space application (e.g., compositor 40, other application 42, etc.) operating in the user space. In some instances, the method of FIG. 3 can include, at 1000, performing one or more operations or using one or more components described above with respect to FIG. 1.

At 1002, the method of FIG. 3 can include providing, by the first user-space application to a passthrough socket (e.g., passthrough socket 36) associated with a display component (e.g., display server 34, etc.) external to the virtual machine, the data indicative of the display frame. In some instances, the method of FIG. 3 can include, at 1002, performing one or more operations or using one or more components described above with respect to FIG. 1.

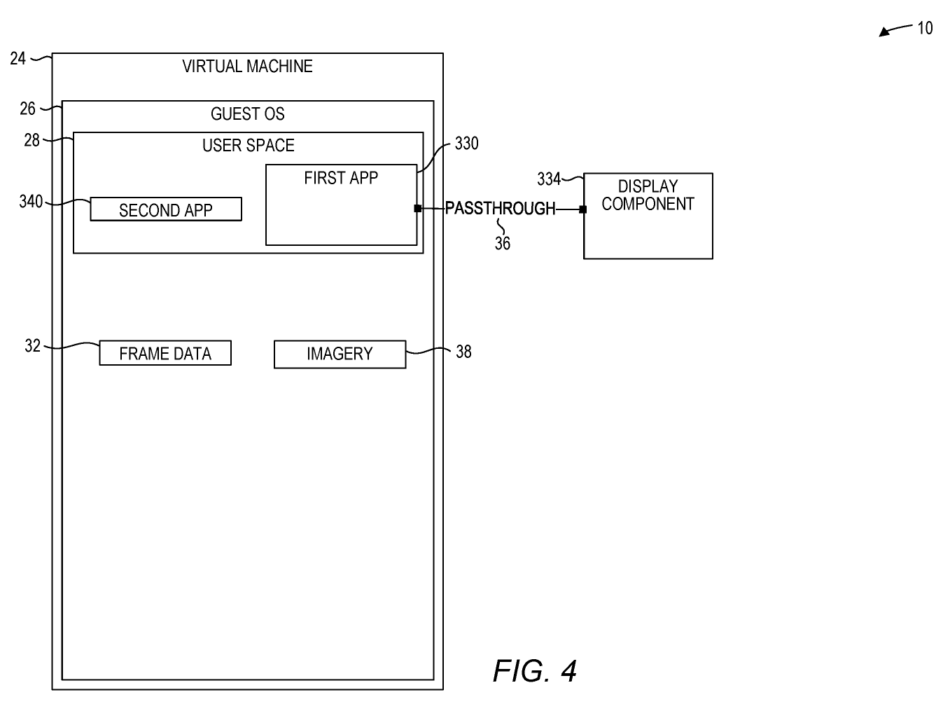

FIG. 4 is a simplified block diagram of the environment illustrated in FIG. 1 according to one implementation. A first application 330 operating in a user space 28 of a guest operating system 26 of a virtual machine 24 can obtain data 32 indicative of a display frame associated with the virtual machine 24, wherein the display frame comprises imagery 38 generated by a second user-space application 340 operating in the user space. The first application 330 can provide the data 32 indicative of the display frame to a passthrough socket 36 associated with a display component 334 external to the virtual machine 24.

In some instances, a first application 330 can be, comprise, be comprised by, or otherwise share one or more properties with a display application 30. For example, in some instances, a first application 330 can have any property described above with respect to a display application 30.

In some instances, a display component 334 can be, comprise, be comprised by, or otherwise share one or more properties with a display server 34. For example, in some instances, a display component 334 can have any property described above with respect to a display server 34.

In some instances, a second user-space application 340 can be, comprise, be comprised by, or otherwise share one or more properties with a compositor 40 or other application 42. For example, in some instances, a second user-space application 340 can have any property described above with respect to a compositor 40 or other application 42.

FIG. 5 is a block diagram of a computing device 530 suitable for implementing examples according to one example. The computing device 530 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 530 includes the processor device 532, the system memory 550, and a system bus 546. The system bus 546 provides an interface for system components including, but not limited to, the system memory 550 and the processor device 532. The processor device 532 can be any commercially available or proprietary processor.

The system bus 546 may be any of several types of bus structures that may further interconnect to a memory bus (with or without a memory controller), a peripheral bus, and/or a local bus using any of a variety of commercially available bus architectures. The system memory 550 may include non-volatile memory 566 (e.g., read-only memory (ROM), erasable programmable read-only memory (EPROM), electrically erasable programmable read-only memory (EEPROM), etc.), and volatile memory 568 (e.g., random-access memory (RAM)). A basic input/output system (BIOS) 570 may be stored in the non-volatile memory 566 and can include the basic routines that help to transfer information between elements within the computing device 530. The volatile memory 568 may also include a high-speed RAM, such as static RAM, for caching data.

The computing device 530 may further include or be coupled to a non-transitory computer-readable storage medium such as the storage device 554, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 554 and other drives associated with computer-readable media and computer-usable media may provide non-volatile storage of data, data structures, computer-executable instructions, and the like.

A number of modules can be stored in the storage device 554 and in the volatile memory 568, including an operating system 556 and one or more program modules, such as the display application 30, which may implement the functionality described herein in whole or in part. All or a portion of the examples may be implemented as a computer program product 558 stored on a transitory or non-transitory computer-usable or computer-readable storage medium, such as the storage device 554, which includes complex programming instructions, such as complex computer-readable program code, to cause the processor device 532 to carry out the steps described herein. Thus, the computer-readable program code can comprise software instructions for implementing the functionality of the examples described herein when executed on the processor device 532. The processor device 532, in conjunction with the display application 30 in the volatile memory 568, may serve as a controller, or control system, for the computing device 530 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 532 through an input device interface 560 that is coupled to the system bus 546 but can be connected by other interfaces such as a parallel port, an Institute of Electrical and Electronic Engineers (IEEE) 1394 serial port, a Universal Serial Bus (USB) port, an IR interface, and the like. The computing device 530 may also include the communications interface 562 suitable for communicating with a network as appropriate or desired. The computing device 530 may also include a video port configured to interface with a display device, to provide information to a user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a first user-space application operating in a user space of a guest operating system of a virtual machine, data indicative of a display frame associated with the virtual machine, wherein the display frame comprises imagery generated by a second user-space application operating in the user space; and
providing, by the first user-space application to a passthrough socket associated with a display component external to the virtual machine, the data indicative of the display frame.

2. The method of claim 1, wherein the data indicative of the display frame is first data, and obtaining the data indicative of the display frame comprises:
accessing, by the first user-space application, a frame buffer;
providing, by the first user-space application to the second user-space application, access to the frame buffer; and
accessing, by the first user-space application from the frame buffer, the first data or second data indicative of the display frame.

3. The method of claim 2, wherein providing access to the frame buffer comprises:
designating, by the first user-space application via an application programming interface of the guest operating system, the second user-space application as an authorized entity for writing to the frame buffer.

4. The method of claim 2, further comprising:
designating, by the first user-space application via an application programming interface of the guest operating system, the first user-space application as an owner of the frame buffer.

5. The method of claim 2, further comprising:
writing, by the second user-space application, the first data or the second data to the frame buffer.

6. The method of claim 2, wherein the frame buffer is a first frame buffer, and providing the first data to the passthrough socket comprises:
retrieving, by the first user-space application, the first data or the second data from the first frame buffer; and
writing, by the first user-space application based at least in part on the first data or the second data, the first data to a second frame buffer, wherein the display component has read access to the second frame buffer.

7. The method of claim 1, wherein providing the data indicative of the display frame to the passthrough socket comprises:
causing, by the first user-space application, the data indicative of the display frame to be written to a frame buffer for which the display component has read access; and
providing, by the first user-space application, a signal to the display component to cause the display component to display a frame based on the frame buffer.

8. The method of claim 7, wherein the display component is a display server application operating on a host device of the virtual machine, and further comprising:
requesting, by the first user-space application from the display server application, allocation of the frame buffer in memory space shared between the first user-space application and the display server application; and
receiving, by the first user-space application from the display server application, data indicative of a successful allocation of the frame buffer.

9. The method of claim 8, further comprising:
obtaining, by the first user-space application from the display server application, data indicative of one or more display formats supported by the display server application; and
obtaining, by the first user-space application from a configuration file, data indicative of one or more display configurations;
wherein requesting the allocation of the frame buffer is based at least in part on at least one of:
the one or more display formats supported by the display server application; and
the one or more display configurations.

10. The method of claim 7, further comprising:
receiving, by the first user-space application from the guest operating system, an indication that the frame buffer is not currently being written to;
wherein the signal is provided responsive to receiving the indication.

11. The method of claim 7, wherein providing the signal comprises:
generating, by the first user-space application based at least in part on a communication protocol associated with the display component, a message formatted according to the communication protocol; and
providing, by the first user-space application to the display component, the message.

12. The method of claim 11, wherein generating the message comprises:
obtaining, by the first user-space application, one or more display parameters associated with the display frame; and
including in the message, by the first user-space application, data indicative of the one or more display parameters.

13. The method of claim 1, wherein the second user-space application comprises a compositing window manager, and further comprising:
receiving, by the second user-space application from a third user-space application, data indicative of a first display region associated with the third user-space application;
receiving, by the second user-space application from a fourth user-space application, data indicative of a second display region associated with the fourth user-space application; and
compositing, by the compositing window manager based at least in part on the first display region and the second display region, the display frame.

14. The method of claim 1, further comprising:
initializing, by a virtual machine monitor associated with the virtual machine, the first user-space application; and
initializing, by the virtual machine monitor, the passthrough socket.

15. The method of claim 1, further comprising:
during a startup process of the virtual machine:
determining, by the first user-space application, whether the passthrough socket is available; and
causing, by the first user-space application responsive to determining that the passthrough socket is available, a frame buffer to be initialized.

16. The method of claim 1, wherein the virtual machine is operating on an on-board computing device of a vehicle comprising the on-board computing device.

17. The method of claim 16, wherein the vehicle is a road vehicle, and further comprising:
controlling, by the on-board computing device, one or more vehicle functions that are classified by ISO 26262 2018 edition as automotive safety integrity level (ASIL) A, ASIL B, ASIL C, or ASIL D.

18. The method of claim 1, wherein the passthrough socket is a Wayland passthrough socket, and the display component is a Wayland compositor.

19. A computing system comprising:
one or more computing devices to:
obtain, by a first user-space application operating in a user space of a guest operating system of a virtual machine, data indicative of a display frame associated with the virtual machine, wherein the display frame comprises imagery generated by a second user-space application operating in the user space; and
provide, by the first user-space application to a passthrough socket associated with a display component external to the virtual machine, the data indicative of the display frame.

20. A non-transitory computer-readable storage medium that includes executable instructions to cause one or more processor devices to:
obtain, by a first user-space application operating in a user space of a guest operating system of a virtual machine, data indicative of a display frame associated with the virtual machine, wherein the display frame comprises imagery generated by a second user-space application operating in the user space; and
provide, by the first user-space application to a passthrough socket associated with a display component external to the virtual machine, the data indicative of the display frame.
